(19) United States
(12) Patent Application Publication
(10) Pub. No.: US 2015/0026962 A1
(43) Pub. Date: Jan. 29, 2015

(54) DEVICE FOR ATTACHING CHIP ON FILM ONTO PANEL AND METHOD FOR USING THE SAME

(71) Applicant: Fangfu Chen, Shenzhen (CN)

(72) Inventor: Fangfu Chen, Shenzhen (CN)

(73) Assignee: SHENZHEN CHINA STAR OPTOELECTRONICS TECHNOLOGY CO., LTD., Shenahen, Guangdong (CN)

(21) Appl. No.: 14/240,369

(22) PCT Filed: Jan. 28, 2014
(86) PCT No.: PCT/CN2014/071667

§ 371 Date: Oct. 10, 2014

(30) Foreign Application Priority Data
Jul. 19, 2013 (CN) 201310307219.1

(51) Int. Cl. G02F 1/1333

(52) U.S. Cl. CPC G02F 1/1333
USPC 29/593; 29/740

(57) ABSTRACT

The present disclosure relates to a device for attaching a chip on film onto a panel and the method of use the device. The device comprises a platform for conveying the panel, a pressure head for carrying the chip on film, and a panel supporting mechanism in cooperation with the pressure head during use. The device further comprises a distance-adjusting mechanism for measuring a distance between the panel and the supporting mechanism after the panel is placed between the pressure head and the supporting mechanism, and reducing the distance. According to the device of the present disclosure, the distance between the panel and the supporting mechanism can be reduced, so that the deflection occurred during attachment of the chip on film can be avoided. Therefore, the quality of the final product obtained can be improved.

### FIELD OF THE INVENTION

The present disclosure relates to the field of manufacturing liquid crystal modules, and in particular to a device for attaching a chip on film onto a panel. The present disclosure further relates to a method for using the device.

### BACKGROUND OF THE INVENTION

A liquid crystal panel comprises a panel and a chip on film attached thereto. The chip on film, generally called as COF in short, is very thin. In order to attach the chip on film onto the panel, a device for attaching a chip on film is generally used.

FIG. 1 schematically shows a device for attaching a chip on film onto a panel in the prior art. During attaching the chip on film onto the panel, the chip on film 120 is firstly suctioned by a pressure head 110. Then, the panel 140 is moved to the position of the pressure head 110 by means of a servo platform 130, and a supporting mechanism 150 is arranged at a position just below the panel 140 for supporting. The chip on film 120 can be attached onto the panel 140 by virtue of the cooperation of the pressure head 110 and the supporting mechanism 150. During this process, in order to prevent the interaction between the panel 140 and the supporting mechanism 150, the device is configured in such a way that a gap 160 exists between the panel 140 and the supporting mechanism 150. Therefore, when the pressure head 110 moves downwards, bending of the panel 140 will be generated due to existence of the gap 160, thus causing deflection of the chip on film 120. This will bring about adverse effects on the quality of a product obtained.

### SUMMARY OF THE INVENTION

Aiming at the aforementioned technical problem existing in the prior art, the present disclosure provides a device for attaching a chip on film onto a panel, in order to reduce a distance between the panel and the supporting mechanism, thus preventing the attachment of the chip on film from deflection, and then improving the quality of the product. The present disclosure further relates to a method for using the device.

1) According to the first aspect of the present disclosure, a device for attaching a chip on film onto a panel is provided, comprising a platform for conveying the panel, a pressure head for carrying the chip on film, and a panel supporting mechanism in cooperation with the pressure head during use, wherein the device further comprises a distance-adjusting mechanism for measuring a distance between the panel and the supporting mechanism after the panel is placed between the pressure head and the supporting mechanism and reducing the distance.

According to the device of the present disclosure, with the distance-adjusting mechanism, the distance between the panel and the supporting mechanism can be reduced, so that the panel and the supporting mechanism can be accurately contacted with each other. In this manner, bending of the panel when the pressure head presses downwards can be significantly reduced, and the deflection occurred during attachment of the chip on film can be eliminated. Therefore, the quality of the final product obtained can be improved.

2) In a preferred embodiment of 1) of the present disclosure, the distance-adjusting mechanism comprises a distance-measuring assembly for measuring the distance between the panel and the supporting mechanism, and a driving assembly for driving the platform to move based on the distance so as to reduce the distance. In a preferred example, the distance-measuring assembly is fixedly mounted on the supporting mechanism. In this case, the distance-measuring assembly is stationary and only the platform moves. Therefore, the distance-measuring assembly can accurately measure the distance between the panel and the supporting mechanism with the supporting mechanism as a reference, and then accurately controls the movement of the platform.

3) In a preferred embodiment of 1) or 2) of the present disclosure, the distance-adjusting mechanism comprises a distance-measuring assembly for measuring the distance between the panel and the supporting mechanism, and a driving assembly for driving the supporting mechanism to move based on the distance so as to reduce the distance.

4) In a preferred embodiment of any one of 1) to 3) of the present disclosure, the distance-measuring assembly can be a photoelectric distance measurer. The driving assembly can be a servo motor. The distance-adjusting mechanism further comprises a data processing unit which is in communication with the distance-measuring assembly and the driving assembly, and used for controlling the operation of the driving assembly based on the distance measured by the distance-measuring assembly. The data processing unit can be a programmable logic controller. In this case, an optical distance detection technology and a programmable logic control technology can be used together for realizing automatic control, reducing labor intensity, and avoiding the risk of human operation errors. Preferably, the data processing unit, the distance-measuring assembly and the driving assembly are in wireless communication among each other.

5) According to the second aspect of the present disclosure, a method for using the aforementioned device is provided, comprising the following steps:
(a) conveying, through the platform, the panel to a position between the pressure head carrying the chip on film and the supporting mechanism;
(b) adjusting, through the distance-adjusting mechanism, the distance between the panel and the supporting mechanism to a predetermined value; and
(c) moving the pressure head towards the panel, and attaching the chip on film onto the panel.

6) In a preferred embodiment of 5) of the present disclosure, in step (a), the distance between the pressure head and the supporting mechanism is set as greater than the thickness of the panel. In this case, the panel can be conveniently placed between the pressure head and the supporting mechanism.

7) In a preferred embodiment of 5) or 6) of the present disclosure, in step (b), the distance is adjusted to a value between 0.1 and 0.2 μm. The distance within the range is small enough so that the problem of deflection of the chip on film during attachment of the chip on film can be avoided.

Compared with the prior art, the present disclosure has the following advantages. According to the device of the present disclosure, the distance-adjusting mechanism is used to reduce the distance between the panel and the supporting mechanism, so that the panel and the supporting mechanism can be accurately contacted with each other, thus greatly reducing the bending of the panel when the pressure head moves downwards and eliminating the deflection occurred during attachment of the chip on film. Consequently, the quality of the product obtained can be improved. In addition, the distance-adjusting mechanism comprises a photoelectric distance measurer, a servo motor and a programmable logic controller. In this case, an optical distance detection technology and a programmable logic control technology can be used together for realizing automatic control, reducing labor intensity, and avoiding the risk of human operation errors.

### BRIEF DESCRIPTION OF THE DRAWINGS

The present disclosure will be described in more detail below based on the embodiments with reference to the accompanying drawings, in which:

FIG. 1 is a schematic diagram of a device for attaching a chip on film onto a panel in the prior art;

FIG. 2 is a schematic diagram of a device for attaching a chip on film onto a panel according to the present disclosure; and

FIG. 3 schematically shows how to attach the chip on film onto a panel with the device according to the present disclosure.

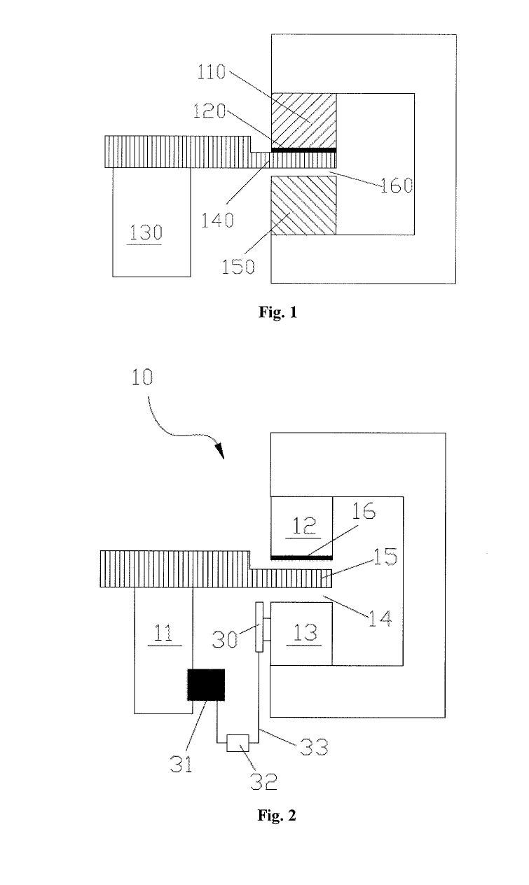

In the accompanying drawings, the same components are indicated by the same reference signs. The accompanying drawings are not drawn in an actual scale.

### DETAILED DESCRIPTION OF THE EMBODIMENTS

The present disclosure will be further illustrated below in conjunction with the accompanying drawings.

FIG. 2 schematically shows a device 10 for attaching a chip on film onto a panel according to the present disclosure (referred to as device 10 below). The device 10 comprises a platform 11, a pressure head 12, a supporting mechanism 13 in cooperation with the pressure head 12 during use (for example, the pressure head 12 and the supporting mechanism 13 are arranged as directly opposite to each other), and a distance-adjusting mechanism. Among others, the platform 11 is used for conveying the panel 15, the pressure head 12 is used for carrying the chip on film 16, and the distance-adjusting mechanism is used for measuring a distance between the panel 15 and the supporting mechanism 13 after the panel 15 is placed between the pressure head 12 and the supporting mechanism 13, and then reducing the distance. Of course, the device 10 also includes some other components, which are known well by those skilled in the art and are not described here for the sake of conciseness.

As shown in FIG. 2, the distance-adjusting mechanism comprises a distance-measuring assembly 30 for measuring a distance between the panel 15 and the supporting mechanism 13, a driving assembly 31 for driving the platform 11 to move up and down, and a data processing unit 32 for processing data from the distance-measuring assembly 30 and controlling the operation of the driving assembly 31 based on the data. In the context, the term “up” is defined as a direction away from the panel 15, and the term “down” is defined as a direction toward the panel 15. The distance-measuring assembly 30, the driving assembly 31 and the data processing unit 32 are connected together through a wire cable 33 to form a complete loop. In an example, the distance-measuring assembly 30, the driving assembly 31 and the data processing unit 32 can also perform data transmission in a wireless manner, so that the device 10 can be configured with a simple structure as a whole, and the damages to the whole device 10 caused by accidental damages to the wire cable 33 are avoided.

In order to accurately control the movement of the panel 15 to reduce the distance between the panel 15 and the supporting mechanism 13, in an example, the distance-measuring assembly 30 is fixedly mounted on the supporting mechanism 13. When the distance between the panel 15 and the supporting mechanism 13 is adjusted, the supporting mechanism 13 is kept stationary, and only the panel 15 moves towards the supporting mechanism 13 by means of the platform 11. In this case, the distance-measuring assembly 30 can accurately measure the distance between the panel 15 and the supporting mechanism 13 with the supporting mechanism 13 as a reference, and then accurately control the movement of the panel 15. In a specific example, the distance-measuring assembly 30 can be a photoelectric distance measurer, the driving assembly 31 can be a servo motor, and the data processing unit 32 can be a programmable logic controller (namely, PLC). It should be also understood that, although in the present disclosure the distance between the panel 15 and the supporting mechanism 13 is reduced by movement of the panel 15, the distance between the panel 15 and the supporting mechanism 13 can also be reduced by movement of the supporting mechanism 13.

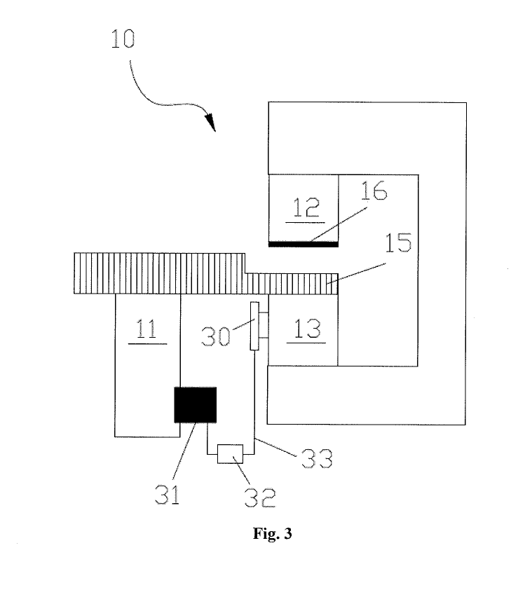

A method for detecting the distance by using the device 10 is described below in conjunction with FIGS. 2 and 3.

Firstly, the panel 15 is loaded on the platform 11, and the chip on film 16 is loaded on the pressure head 12. The distance between the pressure head 12 and the supporting mechanism 13 is set as greater than the thickness of the panel 15, so that the panel 15 can be placed between the pressure head 12 and the supporting mechanism 13. In an example, the distance between the pressure head 12 and the supporting mechanism 13 is in a range of 5-20 mm. Then, the panel 15 is placed between the pressure head 12 and the supporting mechanism 13 (as shown in FIG. 2), and the distance 14 between the panel 15 and the supporting mechanism 13 is measured by the distance-measuring assembly 30 (for example, a photoelectric distance measurer). The data processing unit 32 processes the distance data from the distance-measuring assembly 30, and controls the operation of the driving assembly 31 based on the distance data. Therefore, the platform 11 is driven to move up and down, and the distance 14 between the panel 15 and the supporting mechanism 13 can be adjusted to a predetermined value (as shown in FIG. 3). In an example, the distance is adjusted to 0.1 to 0.2 μm. Finally, the pressure head 12 moves towards the panel 15 and the chip on film 16 is attached onto the panel 15 accordingly, so as to complete the attachment of the chip on film 16. Because the distance between the panel 15 and the supporting mechanism 13 is small enough, the problem of deflection of the chip on film 16 during the attachment of the chip on film 16 can be avoided.

Although the present disclosure has been described with reference to the preferred examples, various modifications could be made to the present disclosure without departing from the scope of the present disclosure and components in the present disclosure could be substituted by equivalents. Particularly, as long as structural conflicts do not exist, all technical features mentioned in all the embodiments may be combined together in any mode. The present disclosure is not limited to the specific examples disclosed in the description, but includes all technical solutions falling into the scope of the claims.

1. A device for attaching a chip on film onto a panel, comprising a platform for conveying the panel, a pressure head for carrying the chip on film, and a panel supporting mechanism in cooperation with the pressure head during use,
wherein the device further comprises a distance-adjusting mechanism for measuring a distance between the panel and the supporting mechanism after the panel is placed between the pressure head and the supporting mechanism and reducing the distance.

2. The device according to claim 1, wherein the distance-adjusting mechanism comprises a distance-measuring assembly for measuring the distance between the panel and the supporting mechanism, and a driving assembly for driving the platform to move based on the distance so as to reduce the distance.

3. The device according to claim 2, wherein the distance-measuring assembly is a photoelectric distance measurer, and the driving assembly is a servo motor.

4. The device according to claim 3, wherein the distance-adjusting mechanism further comprises a data processing unit, which is in communication with the distance-measuring assembly and the driving assembly and can control the operation of the driving assembly based on the distance measured by the distance-measuring assembly.

5. The device according to claim 4, wherein the data processing unit, the distance-measuring assembly and the driving assembly are in wireless communication among each other.

6. The device according to claim 5, wherein the data processing unit is a programmable logic controller.

7. The device according to claim 6, wherein the distance-measuring assembly is fixedly mounted on the supporting mechanism.

8. The device according to claim 1, wherein the distance-adjusting mechanism comprises a distance-measuring assembly for measuring the distance between the panel and the supporting mechanism, and a driving assembly for driving the supporting mechanism to move based on the distance so as to reduce the distance.

9. The device according to claim 8, wherein the distance-measuring assembly is a photoelectric distance measurer, and the driving assembly is a servo motor.

10. The device according to claim 9, wherein the distance-adjusting mechanism further comprises a data processing unit, which is in communication with the distance-measuring assembly and the driving assembly and can control the operation of the driving assembly based on the distance measured by the distance-measuring assembly.

11. The device according to claim 10, wherein the data processing unit, the distance-measuring assembly and the driving assembly are in wireless communication among each other.

12. The device according to claim 11, wherein the data processing unit is a programmable logic controller.

13. A method for using a device for attaching a chip on film onto a panel, which comprises a platform for conveying the panel, a pressure head for carrying the chip on film, and a panel supporting mechanism in cooperation with the pressure head during use, wherein the device further comprises a distance-adjusting mechanism for measuring a distance between the panel and the supporting mechanism after the panel is placed between the pressure head and the supporting mechanism and reducing the distance,
the method comprising the following steps:
(a) conveying, through the platform, the panel to a position between the pressure head carrying the chip on film and the supporting mechanism;
(b) adjusting, through the distance-adjusting mechanism, the distance between the panel and the supporting mechanism to a predetermined value; and
(c) moving the pressure head towards the panel, and attaching the chip on film onto the panel.

14. The method according to claim 13, wherein in step (a), the distance between the pressure head and the supporting mechanism is set as greater than the thickness of the panel.

15. The method according to claim 14, wherein in step (b), the distance is adjusted to a value between 0.1 and 0.2 μm.
